(19) United States
(12) Patent Application Publication
(10) Pub. No.: US 2007/0039976 A1
(43) Pub. Date: Feb. 22, 2007

(54) DISPENSER FOR DISINFECTING GEL

(75) Inventors: George Saleh, Kansas City, MO (US); Caleob King, Quenemo, KS (US)

Correspondence Address: LATHROP & GAGE LC, 4845 PEARL EAST CIRCLE, SUITE 300, BOULDER, CO, 80301, US

(73) Assignee: George Saleh, Kansas City, MO (US)

(21) Appl. No.: 11/343,009

(22) Filed: Jan. 30, 2006

(51) Int. Cl. B67D 5/64; B67D 5/06; B65D 37/00

(52) U.S. Cl. 222/175; 222/181.1; 222/214

(57) ABSTRACT

Portable dispensers and methods of use are disclosed herein. A portable dispenser includes an output device and a housing having a receiving area configured to accept a container having an opening and housing a viscous fluid (i.e., a disinfecting gel). The housing also includes a fastener for selective attachment to an article of clothing. The output device is selectively coupled to the container so that the viscous fluid may selectively pass from the container through the container opening and the output device. An output device of another portable dispenser is selectively coupled to the container so that the fluid may selectively pass from the container through the container opening and the output device without first being transferred from the container to the dispenser for storage. Methods for using the portable dispensers are also provided.

### BACKGROUND OF THE INVENTION

This invention relates generally to a dispenser for disinfecting gel. In particular, the present invention relates to a dispenser for disinfecting gel that is attachable to an article of clothing and that may be used with one hand without first transferring the gel from the container in which it is purchased to the dispenser.

To stop the spread of infection and illness, it is desirable that many people and especially those in the healthcare industry—frequently sanitize their hands. While soap and water is not a convenient option due to the immobile nature of plumbing, disinfecting gel is a sanitary alternative. There are currently disinfecting gels on the market that claim to kill 99.99% of the most common germs that may cause illness in as little as 15 seconds, and many of these additionally include moisturizers that are good for skin.

Nevertheless, these disinfecting gels currently come in capped bottles that are not convenient to use for a variety of reasons. To name a few, these bottles must be carried in a pocket or in a similar manner, these bottles must be manually opened and closed every time they are used, and these bottles are often lost. Simply put, it is often inconvenient or impractical to use these bottles as often as would be desirable.

To overcome these shortcomings, a portable dispenser for a viscous fluid (i.e., a disinfecting gel) is described herein, along with methods of use.

### SUMMARY OF THE INVENTION

Portable dispensers and methods of use are disclosed herein. A portable dispenser of one embodiment includes an output device and a housing having a receiving area configured to accept a container having an opening and housing a viscous fluid. The housing also includes a fastener for selective attachment to an article of clothing. The output device is selectively coupled to the container so that the viscous fluid may selectively pass from the container through the container opening and the output device.

In an embodiment, a dispenser for a disinfecting gel is provided, including a housing, a fastener, and an output device. The housing has a receiving area configured to receive a container having an opening and housing the disinfecting gel. The fastener is attached to the housing for selectively attaching the housing to an article of clothing. The output device is selectively coupled to the container so that the disinfecting gel may selectively pass from the container through the container opening and the output device without first being transferred from the container to the dispenser for storage.

In an embodiment, a method for dispensing a disinfecting gel from a container having an opening is provided. The method includes the steps of providing a dispenser that has an output device and a housing, coupling the output device and the container, and selectively releasing an amount of the disinfecting gel from the container through the output device. The dispenser housing defines a receiving area configured for accepting the container, and the dispenser housing has a fastener for selective attachment to an article of clothing.

### BRIEF DESCRIPTION OF THE DRAWINGS

FIG. 1 is a perspective view showing a portable dispenser for a viscous fluid coupled to a container according to an embodiment.

FIG. 2 is a side view showing the portable dispenser as in FIG. 1 coupled to a container.

FIG. 3 is a sectional view taken from FIG. 2, showing a pump head at a pushed position.

FIG. 4 is the sectional view as in FIG. 3, showing the pump head at a released position.

FIG. 5 is a sectional view taken from FIG. 3, according to an embodiment.

FIG. 6 is a sectional view taken from FIG. 4, according to an embodiment.

FIG. 7 is a perspective view showing a portable dispenser for a viscous fluid coupled to a container according to another embodiment.

FIG. 8 is an exploded view showing the portable dispenser and container as in FIG. 7.

FIG. 9 is a rear view showing the portable dispenser and container as in FIG. 8.

FIG. 10 is a sectional view taken along line A-A of FIG. 9, with an outlet tube at an open configuration.

FIG. 11 is a sectional view showing the portable dispenser and container as in FIG. 10, with the outlet tube at a closed configuration.

FIG. 12 is a perspective view showing a portable dispenser for a viscous fluid coupled to a container according to yet another embodiment.

FIG. 13 is an exploded view showing the portable dispenser and container as in FIG. 12.

FIG. 14 is a front view showing the portable dispenser and container as in FIG. 12.

FIG. 15 is a sectional view taken along line A-A of FIG. 14, with a rocker at a first configuration.

FIG. 16 is a sectional view showing the portable dispenser and container as in FIG. 15, with a rocker at a second configuration.

### DESCRIPTION OF THE PREFERRED EMBODIMENT

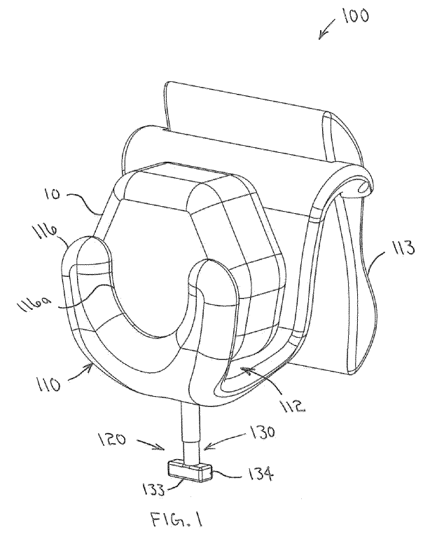

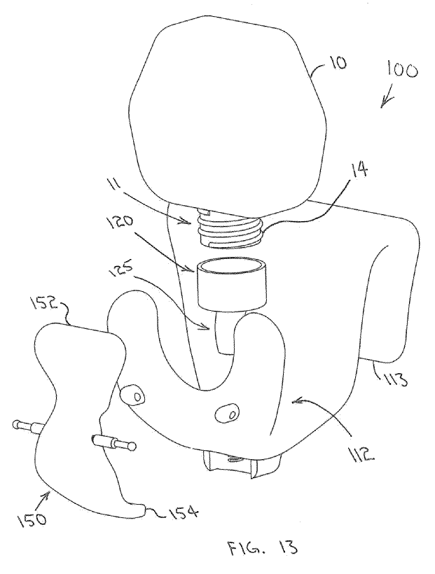

A portable dispenser according to the present invention will now be described in detail with reference to FIGS. 1 through 16 of the accompanying drawings. More particularly, a portable dispenser 100 for a viscous fluid (i.e., a disinfecting gel) housed in a container 10 having an opening 12 includes a housing 110 and an output device 120.

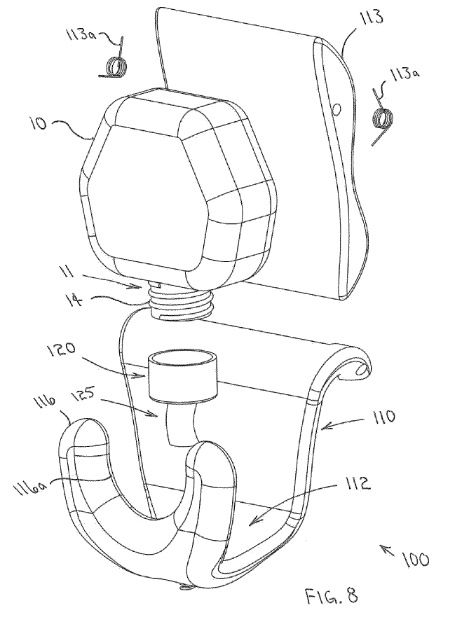

As shown throughout the drawings, the housing 110 includes a receiving area 112 configured to accept the container 10, and a fastener 113 may be included for selectively attaching the housing 110 to an article of clothing (i.e., a belt or pocket). The fastener 113 may be integral with the housing 110 (FIGS. 12 through 16), or the fastener 113 may be coupled to the housing 110 (FIGS. 1 and 7 through 11) and biased by a spring 113a or another resilient member (FIG. 8).

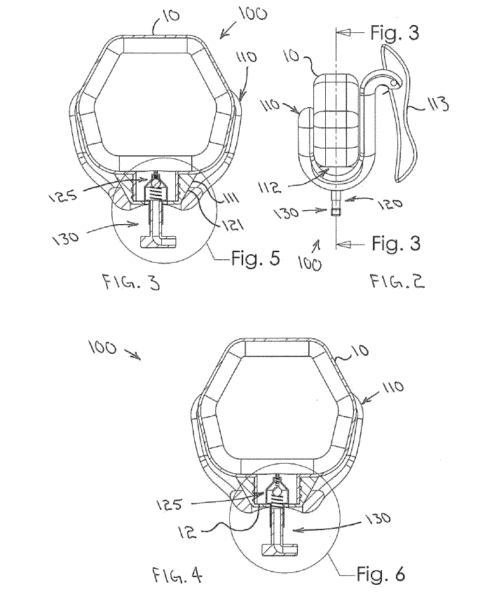

The output device 120 is selectively combinable with the container 10 so that the viscous fluid may selectively pass from the container 10 through the container opening 12 and the output device 120 without first being transferred from the container 10 to the dispenser 100 for storage. As many containers 10 include threads 14 adjacent their respective container opening 12, the output device 120 may include threads 124 complementary to the container threads 14 for selectively attaching the container 10 and the output device 120. The threads 124 are best shown in FIGS. 3 through 6. The output device 120 may be combinable with the container 10 by utilizing other structure, as well. For example, another protrusion from or cavity in the output device 120 may mate with another protrusion from or cavity in the container 10 to selectively couple the output device 120 and the container 10.

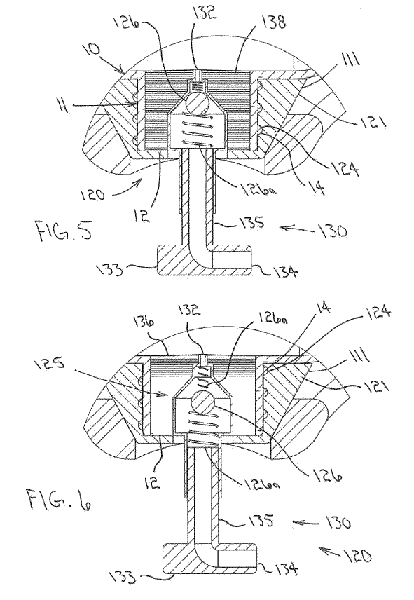

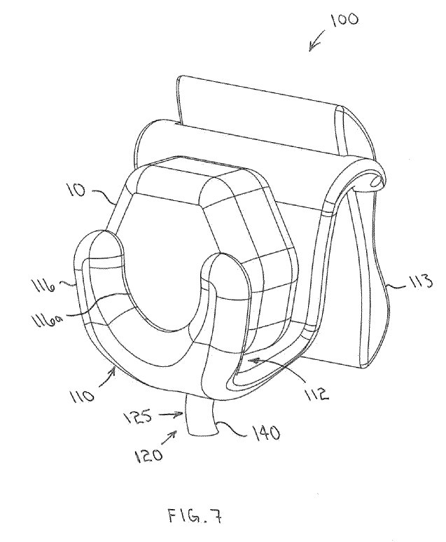

As shown in FIGS. 3 through 6, the output device 120 may be selectively receivable in the housing 110. The output device 120 may be coupled to the housing 110 by friction or by a fastener, and the output device 120 and the housing 110 may present conical mating surfaces 121, 111 to aid in coupling the output device 120 and the housing 110 (FIGS. 5 and 6). Alternately, the output device 120 may be permanently fixed to the housing 110. The output device 120 may include a valve 125 for selectively allowing the viscous fluid to pass through the output device 120.

FIGS. 1 through 6 show that the output device 120 may include a pump 130 for selectively causing the viscous fluid to pass through the output device 120. The pump 130 may include an inlet 132 (FIGS. 5 and 6) and a head 133 having an outlet 134. The valve 125 may have a ball 126 and a spring 126a in communication with a pushrod 135 extending from the head 133, as shown in FIGS. 5 and 6. When the head 133 is pushed (FIGS. 3 and 5), the pushrod 135 may cause the ball 126 to seal the inlet 132, and fluid inside the pump 130 may be forced to exit the outlet 134. When the head 133 is released (FIGS. 4 and 6), the spring 126a may cause the ball 126 to move away from the inlet 132 and fluid to be pulled into the pump 130. Alternately, the pump 130 may utilize other pumping structure.

FIGS. 5 and 6 show that the pump 130 may seal a neck 11 of the container 10 adjacent the opening 12 and that the inlet 132 may be adjacent the neck 11. This allows all of the viscous fluid in the container 10 to enter the pump inlet 132 and exit the output device 120; otherwise, an amount of the fluid may become trapped in the neck 11 and unable to exit the pump 130. As shown in FIG. 5, a plug 138 may be coupled to or formed with the pump 130 to seal the container neck 11. As shown in FIG. 6, a seal 136 may extend outwardly from the inlet 132 to seal the container neck 11. The seal 136 and the plug 138 may be constructed of plastic, rubber, or another material.

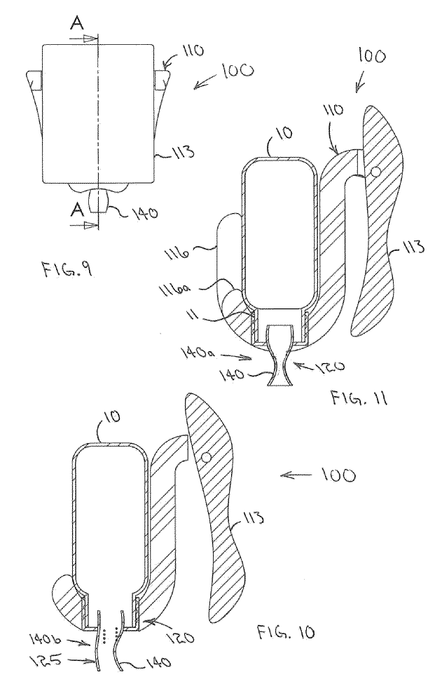

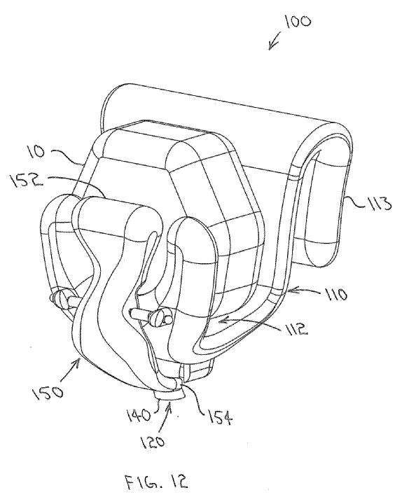

FIGS. 7 through 16 show that the valve 125 of the output device 120 may include an outlet tube 140 adjustable between a closed configuration 140a and an open configuration 140b. The outlet tube 140 is preferably biased toward the closed configuration 140a (FIG. 11) to keep the fluid inside the output device 120 and the container 10. By exerting pressure on the container 10, the viscous fluid may be forced through the outlet tube 140. Once the pressure is removed from the container 10, the outlet tube 140 may return from the open configuration 140b (FIG. 10) to the closed configuration 140a (FIG. 11). The housing 110 may include a front wall 116 to shield the container 10 from unwanted contact when the container 10 is attached to the output device 120 and the output device 120 is received in the housing 110, and the front wall 116 may define an opening 116a to allow access to the container 10 so that pressure may be selectively exerted on a wall of the container 10.

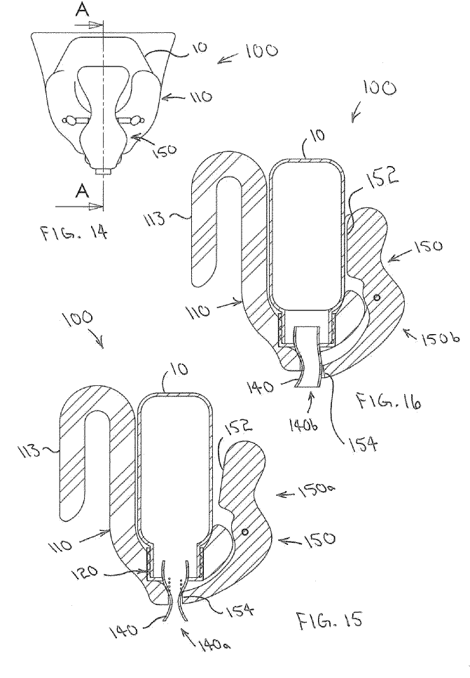

FIGS. 12 through 16 show that a rocker 150 may be coupled to the housing 110 and movable between first and second configurations 150a, 150b. When at the first configuration 150a, a first end 152 of the rocker 150 does not exert a force on the container 10 and a second end 154 of the rocker 150 ensures the outlet tube 140 is at the closed configuration 140a (FIG. 15). When at the second configuration 150b, the rocker first end 152 exerts a force on the container 10 and the rocker second end 154 allows the outlet tube 140 to be at the open configuration 140b (FIG. 16). A spring (not shown) or another resilient member may bias the rocker 150 toward the first rocker configuration 150a so that the outlet tube 140 is normally at the closed configuration 140a. It should be understood that the phrase “does not exert a force on the container 10” herein means “does not exert an appreciable force on the container 10”. In other words, the rocker 150 may contact the container 10 when at the first configuration 150a so long as the rocker 150 does not exert a force on the container 10 that forces the fluid out the outlet tube 140.

In an exemplary method of use, a container 10 housing a disinfecting gel may be coupled to the output device 120, such as by mating the container threads 14 and the output device threads 124. The output device 120 may then be joined to the housing 110 so that the container 10 is located in the housing receiving area 112 and the container opening 12 is below the disinfecting gel when the housing 110 is at a generally upright position (FIGS. 1 through 7, 9 through 12, and 14 through 16). The dispenser 100 may be attached to an article of clothing using the fastener 113, and an amount of the disinfecting gel may be selectively released from the container 10 through the output device 120.

One hand may cause the disinfecting gel to be released from the container 10, and the disinfecting gel may be released from the output device 120 to the one hand. For example, the one hand may press the pump head 133 to cause the gel to exit the outlet 134 if a pump 130 is included; the one hand may press on the container 10 to cause the gel to exit the outlet tube 140 if an outlet tube 140 is included; or the one hand may cause the rocker 150 to move from the first configuration 150a to the second configuration 150b if a rocker 150 is included. If the pump 130 is included, the user does not have to exert a force on a wall of the container 10. In other words, the user does not have to press on the container 10 if a pump 130 is included.

After all of the disinfecting gel is released through the output device 120, the container 10 and the output device 120 may be disassociated. A new container 10 having disinfecting gel may then be coupled to the output device 120 as described above, and the gel may be dispensed through the output device 120 as described above. The disassociated container 10 may be discarded, recycled, or refilled. Notably, the user does not have to transfer the gel from the container 10 to the dispenser 100 prior to dispensing the gel. The receiving area 112 is preferably sized to accommodate a two-ounce container 10 and/or an eight-ounce container 10, though the receiving area 112 may be sized to accommodate other containers 10.

It is understood that while certain forms of this invention have been illustrated and described, it is not limited thereto except insofar as such limitations are included in the following claims and allowable functional equivalents thereof

What is claimed is as follows:

1. A portable dispenser for a viscous fluid, the viscous fluid being housed in a container having an opening, said dispenser comprising:
a housing having a receiving area configured to accept the container and having a fastener for selective attachment to an article of clothing; and
an output device for selective coupling with the container, whereby the viscous fluid may selectively pass from the container through the container opening and the output device.

2. The dispenser of claim 1, wherein:
the container includes threads adjacent the container opening;
the output device includes threads complementary to the threads of the container for selective attachment of the container and the output device; and
the output device includes a pump for selectively causing the viscous fluid to pass through the output device.

3. The dispenser of claim 1, wherein:
the container includes threads adjacent the container opening;
the output device includes threads complementary to the threads of the container for selective attachment of the container and the output device; and
the output device is selectively receivable in the housing.

4. The dispenser of claim 3, wherein the output device includes a valve for selectively allowing the viscous fluid to pass through the output device.

5. The dispenser of claim 4, wherein the valve includes an outlet tube adjustable between a closed configuration and an open configuration.

6. The dispenser of claim 5, wherein:
a rocker is coupled to the housing and movable between a first configuration in which a first end of the rocker does not exert a force on the container and a second end of the rocker ensures the outlet tube is at the closed configuration and a second configuration in which the rocker first end exerts a force on the container and the rocker second end allows the outlet tube to be at the open configuration; and
the rocker is biased toward the first rocker configuration.

7. The dispenser of claim 5, wherein the housing has a front wall to shield the container from unwanted contact when the container is attached to the output device and the output device is received in the housing.

8. The dispenser of claim 7, wherein the front wall defines an opening to allow access to the container so that pressure may be exerted on a wall of the container.

9. The dispenser of claim 1, wherein:
the container has a neck adjacent the container opening;
the output device includes a pump for selectively causing the fluid to pass through the output device;
the pump includes an inlet adjacent the container neck; and
a seal covers the container neck adjacent the pump inlet to allow all of the fluid in the container to selectively enter the pump inlet.

10. The dispenser of claim 1, wherein:
the container has a neck adjacent the container opening;
the output device includes a pump for selectively causing the fluid to pass through the output device;
the pump includes an inlet adjacent the container neck; and
a plug seals the container neck adjacent the pump inlet to allow all of the fluid in the container to selectively enter the pump inlet.

11. A dispenser for a disinfecting gel, the disinfecting gel being housed in a container having an opening, said dispenser comprising:
a housing having a receiving area configured to receive the container;
a fastener attached to the housing for selectively attaching the housing to an article of clothing; and
an output device for selective coupling with the container, whereby the gel may 10 selectively pass from the container through the container opening and the output device without first being transferred from the container to the dispenser for storage.

12. The dispenser of claim 11, wherein the output device includes a pump for selectively causing the viscous fluid to pass through the output device.

13. The dispenser of claim 12, wherein the output device is selectively receivable in the housing.

14. The dispenser of claim 11, wherein the output device includes a valve for selectively allowing the viscous fluid to pass through the output device.

15. The dispenser of claim 14, wherein the valve includes an outlet tube adjustable between a closed configuration and an open configuration.

16. The dispenser of claim 15, wherein:
a rocker is coupled to the housing and movable between a first configuration in which a first end of the rocker does not exert a force on the container and a second end of the rocker ensures the outlet tube is at the closed configuration and a second configuration in which the rocker first end exerts a force on the container and the rocker second end allows the outlet tube to be at the open configuration; and
the rocker is biased toward the first rocker configuration.

17. A method for dispensing a disinfecting gel from a container having an opening, the method comprising the steps of:
providing a dispenser having an output device and a housing, the housing defining a receiving area configured for accepting the container and having a fastener for selective attachment to an article of clothing;
coupling the output device and the container; and
selectively releasing an amount of the disinfecting gel from the container through the output device.

18. The method of claim 17, further comprising the step of joining the output device and the housing so that the container is located in the housing receiving area, whereby the container opening is below the gel when the housing is at a generally upright position;

19. The method of claim 18, wherein:
the step of selectively releasing an amount of disinfecting gel is accomplished by one hand operating the output device; and
the disinfecting gel is released from the output device to the one hand.

20. The method of claim 19, wherein the step of selectively releasing an amount of disinfecting gel is accomplished without exerting a force on a wall of the container.

21. The method of claim 17, wherein:
the step of selectively releasing an amount of disinfecting gel is accomplished by one hand operating the output device; and
the disinfecting gel is released from the output device to the one hand.

22. The method of claim 17, further comprising the step of disassociating the container and the output device after all of the gel from the container is released through the output device.
